(19) United States
(12) Patent Application Publication
(10) Pub. No.: US 2012/0042475 A1
(43) Pub. Date: Feb. 23, 2012

(54) DEVICE TO ASSIST ARTHRITICS AND OTHER INVALIDS IN OPENING A DOOR

(76) Inventors: Mary TsunAn Chiang, Madison, MS (US); Gulrukh Shaheen, Madison, MS (US); Thomas Jacob Wiygul, JR., Madison, MS (US)

(21) Appl. No.: 13/212,348

(22) Filed: Aug. 18, 2011

Related U.S. Application Data
(60) Provisional application No. 61/374,677, filed on Aug. 18, 2010.

(51) Int. Cl. E05B 1/00

(52) U.S. Cl. 16/413

(57) ABSTRACT

A device for assisting in turning a doorknob so as to open a door may include a gripping member, for example, formed of rubber or another such material that is capable of grippingly engaging with a (e.g., round) doorknob. The gripping member may be configured as an elongate strip of rubber or similar material providing friction against the doorknob so that the gripping member will not slip substantially when engaged with the doorknob. The gripping member may be wrapped around the doorknob one or more times. A handle may be attached to the gripping member so that the user may grip the handle and pull laterally relative to the doorknob. Advantageously, no twisting motion of the wrist is required by the user, as the pulling of the handle results in turning of the doorknob as a result of the friction gripping action of the gripping member against the doorknob.

### CROSS-REFERENCE TO RELATED APPLICATIONS

The present application claims the benefit of U.S. Provisional Patent Application Ser. No. 61/374,677 filed Aug. 18, 2010 and entitled DEVICE TO ASSIST ARTHRITICS AND OTHER INVALIDS IN OPENING A DOOR, herein incorporated by reference in its entirety.

### BACKGROUND OF THE INVENTION

1. The Field of the Invention

The present invention relates generally devices for assisting those who otherwise have difficulty in opening a door.

2. The Relevant Technology

Arthritis, or joint inflammation, affects many people of all ages, although it is most common among older people. Such inflammation of the joints can make everyday tasks, such as opening a door, difficult, particularly as a result of the pain associated with the necessary movements.

### SUMMARY OF THE INVENTION

In one embodiment, the present invention is directed to a device for assisting in turning a doorknob so as to open a door. In one embodiment, the device includes a gripping member, for example, formed of rubber or another such material (e.g., elastomeric) that is capable of grippingly engaging with a (e.g., round) doorknob. The gripping member may be configured as an elongate strip of rubber or similar material providing friction against the doorknob so that the gripping member will not slip substantially when engaged with the doorknob. In one embodiment, the gripping member may be wrapped around the doorknob one or more times. In another embodiment, the gripping member is looped around the doorknob, and a strap portion extending between the gripping member and a handle is wrapped around the doorknob. The handle may be attached to the gripping member or strap extending between the gripping member and the handle so that the user may grip the handle and pull outwardly relative to the doorknob. Advantageously, no twisting motion of the wrist is required by the user, as the pulling of the handle results in turning of the doorknob as a result of the friction gripping action of the gripping member against the doorknob. For example, the user may pull the handle laterally outward, upward, or downward.

Another embodiment of the present invention is directed to a related method of use in turning a doorknob.

These and other benefits, advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 depicts an exemplary device according to the present invention.

### DETAILED DESCRIPTION OF THE PREFERRED EMBODIMENTS

The present invention is directed to a device for assisting in turning a doorknob so as to open a door. In one embodiment, the device includes a gripping member, for example, formed of rubber or another such material that is capable of grippingly engaging with a (e.g., round) doorknob. The gripping member may be configured as an elongate strip of rubber or similar material (e.g., an elastomeric material) providing friction against the doorknob so that the gripping member will not slip substantially when engaged with the doorknob. For example, when the gripping member is wrapped or looped around at least a portion of the doorknob, any given position of the gripping member does not move substantially relative to the doorknob when a free end of the gripping member is pulled. Rather, the frictional grip between the gripping member and the adjacent location of the doorknob causes the doorknob to rotate, opening the door. A handle may be attached to a free end of the gripping member or an intervening strap between the gripping member and handle (e.g., while the other end is wrapped around the doorknob) to facilitate easy pulling of the gripping member. The handle may comprise any suitable shape (e.g., round such as a tennis ball, substantially flat such as a kite type handle, a cylindrical “soft” grip” foam handle, etc.). Advantageously, no twisting motion of the wrist is required by the user, as the pulling of the handle results in turning of the doorknob as a result of the friction gripping action of the gripping member against the doorknob. For example, the user may pull the handle laterally outward, upward, or downward.

In one embodiment, the width of the gripping member is no more than about the width of the doorknob. The gripping member may be provided in various colors as desired (e.g., red, green, pink, blue, white, black, etc.).

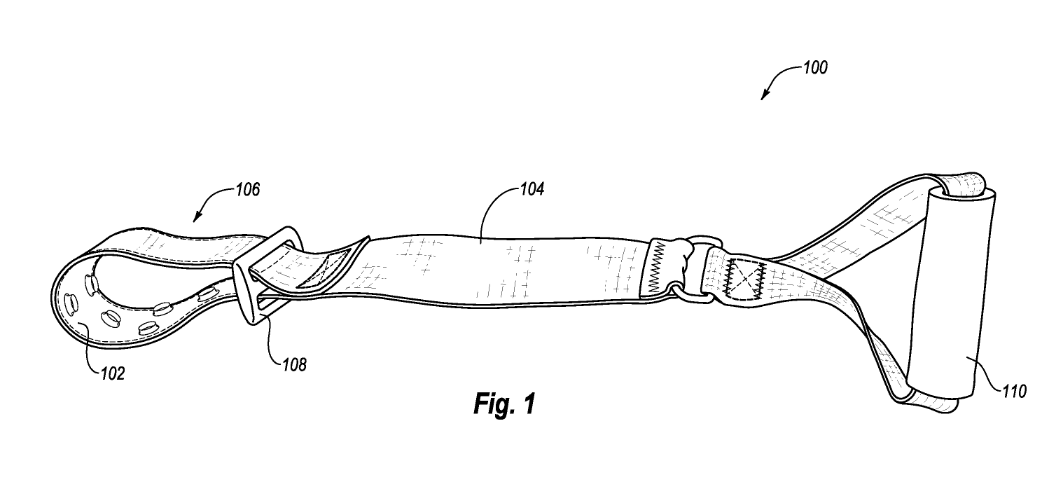

In one embodiment, the handle may be smooth so as to facilitate periodic cleaning and/or disinfection of the handle. A kite handle may be better suited for such cleaning relative to a tennis ball, which is fuzzy. Of course, a smooth spherical handle could be provided. In one embodiment, such as that shown in FIG. 1, the handle 110 is generally cylindrical and may include a padded foam type exterior surface.

In one embodiment, the gripping member may comprise two layers. For example, an elastomeric band or strip of elastomeric material (e.g., similar to that as used in Pilates or physical therapy) may comprise an upper layer and be attached to a lower layer comprising a textured elastomeric gripping layer (e.g., similar to an anti-slip gripping material positioned under a floor rug or on a shelf or in a drawer). The textured gripping layer is positioned adjacent the door knob. Such a textured layer provides particularly good gripping ability. The upper and lower layers may be attached by any suitable means, examples of which include a hook and loop mechanism (e.g., Velcro), stitching (e.g., sewn together) or an adhesive (e.g., a pressure sensitive, contact adhesive).

In one embodiment, the upper and lower layers may not be completely co-extensive. For example, in one embodiment, it may be advantageous to configure the lower, textured layer so that it ends (e.g., about 2 to about 3 inches) before the end of the upper layer, which upper layer is attached to the handle. Such a configuration may facilitate easier sewing or other attachment of the gripping member (i.e., the upper layer) to the handle. In one embodiment, the upper layer may alternatively end prior to the lower layer (i.e., and the lower layer only be attached to the handle).

In one embodiment, a guide may further be provided to hold the gripping member in place against the doorknob so as to prevent a user from pulling the handle (and thus the gripping member) in a direction that is substantially parallel to a longitudinal axis of the door knob (i.e., “out”) rather than laterally sideways, up, or down. In one embodiment, the guide may restrict pulling to one or more particular directions (e.g., substantially straight down).

The handle may be attached to the gripping member by any suitable means, examples of which include a hook and loop mechanism (e.g., Velcro), stitching (e.g., sewn together) or an adhesive (e.g., a pressure sensitive, contact adhesive). It may be particularly preferable to stitch the handle to the gripping member so as to provide a particularly durable connection.

In addition, the handle may be configured so as to accommodate the largest typical adult hand. Such a handle may be larger in size than a typical kite handle as shown in the photographs of the provisional application incorporated by reference, having a larger opening through which the fingers are inserted. For example, such a handle may include an opening for receipt of the fingers which measures at least about 3.5 inches (e.g., about 3.5 to about 6 inches). Similarly, the diameter of a spherical handle may be increased relative to that of a 2 inch tennis ball so as to provide a handle requiring less movement of the gripping hand around the ball. For example, a 3 inch ball requires less curvature of the fingers/hand around the ball than a 2 inch ball. Such a spherical handle may for example measure between about 2 inches and about 4 inches in diameter (e.g., about 2.25 to about 3.5 inches).

Photographs of some exemplary embodiments are shown in Figures filed with the provisional application, already incorporated by reference.

In another embodiment, such as that illustrated in FIG. 1, the upper layer may comprise a fabric (e.g., nylon, cotton, polyester, or blends of various synthetic and/or natural fibers) such as that used in seat belts and that is stitched or otherwise attached to a lower layer of an elastomeric gripping layer. In the illustrated embodiment, the lower layer is formed of a bathmat material including suction cups. A nylon upper layer strap material provides greater strength and durability than an elastomeric band alone. The bathmat suction cups protruding from the surface provide excellent grip. According to an exemplary embodiment, the length of the nylon strap is about 24 inches, the length of the bathmat or other elastomeric material is about 10 inches, and the width of both the nylon strap and bath mat are about 2 inches.

The inventors have found that if the strap and/or gripping member is wrapped around the doorknob at least about twice, this results in easier turning of the knob. A strap length of between about 20 and about 28 inches (e.g., about 24 inches) provides the needed length to achieve this double wrapping.

The device 100 of FIG. 1 includes a loop 106 and buckle 108 with a relatively long, elongate strap 104 and handle 110 attached at an end of strap 104 opposite loop 106. Handle 110 may be coupled to elongate strap 104 through a D-ring, and additional split strap lengths, as shown. Such a ring may be formed of any suitable material (e.g., metal, or plastic). The inside surface of loop 106 includes the gripping bathmat material, and can the diameter of the loop can be adjusted (e.g., tightened) with buckle 108. In this configuration, the user places the loosened loop onto the doorknob and fastens (e.g., cinches) the loop 106 with the buckle 108. It is not necessary that the loop 106 and buckle be very tight. Even a relatively loose loop can sufficiently grip the knob. The nylon strap or band is then wrapped around the knob, over (i.e., behind) the loop (wrap twice for best results). Wrapping the band behind the loop helps anchor the device 100 so that the user can pull up or push down towards them in order to open the door. One possible method of assembly of device 100 is described below.

1. Sew the 10″ bath mat gripping material onto one end of the nylon strap 104 (the end that becomes loop 106) along the edges.

2. Measure 5″ on the strap end with the suction cups and fold it down.

3. Thread the buckle 108 onto the strap 104, pushing one end in and pulling it out the other hole to form a loop 106.

4. Then tighten the buckle 108 to the folded part of the strap 104.

5. Sew the end of the folded strap 104 where it touches the rest of the strap to secure the buckle 108 within the loop 106.

6. Place the ring of the handle on the side of the strap opposite the loop.

7. Fold 1″ of the strap through the handle ring and sew it down securely.

It will also be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. A device for assisting arthritics or other invalids in opening a door, comprising:
a gripping member comprising a slip resistant material that can be wrapped at least partially around a doorknob;
a handle attached to a free end of the gripping member such that when a user pulls the handle in a lateral direction relative to the doorknob, the gripping member rotates the doorknob so as to open a door.

2. A device for assisting arthritics or other invalids in opening a door, comprising:
a gripping member in the form of a loop comprising an elastomeric slip resistant material comprising suction cups that can be looped at least partially around a doorknob, the suction cups being oriented towards and engaging the doorknob during use;
a strap attached to and extending from a free end of the gripping member, the strap having a length sufficient to allow the strap to be wrapped around the doorknob at least twice; and
a handle attached to a free end of the strap such that when a user pulls the handle in a lateral direction relative to the doorknob, the gripping member rotates the doorknob so as to open a door.

3. A device as recited in claim 2, wherein the length of the strap is between about 20 and about 28 inches.

4. A device as recited in claim 2, wherein the length of the strap is about 24 inches.

5. A device as recited in claim 2, wherein the strap is about 2 inches wide.

6. A device as recited in claim 2, further comprising a buckle positioned between the loop of the gripping member and the elongate strap that can be adjusted to tighten or loosen the size of the loop of the gripping member.

7. A method of opening a door comprising:
providing a device for assisting arthritics or other invalids in opening a door, the device comprising:
a gripping member in the form of a loop comprising an elastomeric slip resistant material comprising suction cups that can be looped at least partially around a doorknob, the suction cups being oriented towards and engaging the doorknob during use;
an elongate strap attached to and extending from a free end of the gripping member, the strap having a length sufficient to allow the strap to be wrapped around the doorknob at least twice; and
a handle attached to a free end of the strap such that when a user pulls the handle in a lateral direction relative to the doorknob, the gripping member rotates the doorknob so as to open a door;
looping the gripping member in the form of a loop around a round doorknob so that the suction cups are oriented towards and engage a surface of the doorknob;
wrapping the elongate strap around the doorknob two times, the elongate strap being positioned over the looped gripping member so that the gripping member is between the doorknob and the portion of the elongate strap that is wrapped around the doorknob; and
pulling the handle attached to the elongate strap in a direction that is generally laterally up, down, or sideways relative to an axis about which the doorknob turns so as to rotate the doorknob and open the door.

8. A method as recited in claim 7, wherein the device further comprises a buckle positioned between the loop of the gripping member and the elongate strap that can be adjusted to tighten or loosen the size of the loop of the gripping member, the method further comprising adjusting the buckle to tighten the loop around the doorknob once the gripping member is looped around the doorknob.
